(19) United States
(12) Patent Application Publication
(10) Pub. No.: US 2026/0144229 A1
(43) Pub. Date: May 28, 2026

(54) PET FEEDING DEVICE

(71) Applicant: Joyment Smart CO., LTD., Taipei City (TW)

(72) Inventors: Keng-Kuei FAN, Taipei City (TW); Shih-Yuen HSU, Taipei City (TW)

(21) Appl. No.: 19/181,657

(22) Filed: Apr. 17, 2025

(30) Foreign Application Priority Data
Nov. 27, 2024 (TW) 113145908

(51) Int. Cl. A01K 5/02; A01K 7/02; A01K 29/00

(52) U.S. Cl. CPC A01K 5/02; A01K 7/02; A01K 29/007

(57) ABSTRACT

A pet feeding device includes a pet food and power supply equipment and a pet water dispenser. The pet food and power supply equipment includes a plurality of power chargers, and the pet water dispenser includes a power receiver for electrically connecting one of the power chargers to use the power charger to provide a required power to the pet water dispenser, and adjust the relative positions of the pet water dispenser and the pet food and power supply equipment according to actual needs.

### RELATED APPLICATIONS

This application claims priority to Taiwan Application Serial Number 113145908, filed Nov. 27, 2024, the disclosures of which are incorporated herein by reference in their entireties.

### TECHNICAL FIELD

The present disclosure relates to a feeding device. More particularly, the present disclosure relates to a pet feeding device.

### BACKGROUND

In recent years, with the rapid advancement of technology, various electronic products have been widely used by the public and have gradually become essential in daily life.

Due to demographic changes such as low birth rates, aging populations, and an increase in single or childless individuals, people increasingly seek emotional companionship from pets. As a result, the willingness to keep pets has significantly increased. People now tend to treat pets as family members, ensuring the pets eat healthily and nutritionally rather than feeding the pets with leftovers. Consequently, pet stores, supermarkets, and e-commerce platforms now offer a wide variety of pet food, including dry food, wet food, snacks, and even functional health supplements for pets.

As pets are considered as family members, pet owners are willing to invest more in their well-being. However, due to busy work schedules, irregular working hours, or travel needs, the pet owner is often difficult to feed pets on time. The pet feeding device may provide timed and quantified feeding to ensure that the pet is fed on time so as to improve the convenience and quality of pet care.

However, due to limited living space or interior design requirements, there is a need to provide a flexible pet feeding device that allows pet owners to care for the pets more conveniently.

### SUMMARY

The summary of the present invention is intended to provide a simplified description of the disclosure to enable readers to have a basic understanding of the disclosure. The summary of the present invention is not a complete overview of the disclosure, and it is not intended to point out the importance of the embodiments/key elements of the present invention or define the scope of the invention.

One objective of the embodiments of the present invention is to provide a pet feeding device able to adjust the quantity and relative positions of the pet food and power supply equipment, the pet water dispenser, and the movable surveillance camera according to actual needs.

To achieve these and other advantages and in accordance with the objective of the embodiments of the present invention, as the embodiment broadly describes herein, the embodiments of the present invention provides an pet feeding device including a pet food and power supply equipment and a pet water dispenser. The pet food and power supply equipment includes a plurality of power chargers, while the pet water dispenser includes a power receiver configured to electrically connect to one of the power chargers to provide the necessary power to the pet water dispenser. The relative positions of the pet water dispenser and the pet food and power supply equipment may be adjusted according to an actual need.

In some embodiments, the pet feeding device further includes a movable surveillance camera equipped with a power receiver for electrically connecting to another power charger to supply power to the movable surveillance camera. The relative positions of the movable surveillance camera and the pet water dispenser can be exchanged according to an actual need.

In some embodiments, the pet feeding device further includes an independent charging base able to be placed outside the pet food and power supply equipment according to an actual need to provide the required power for the movable surveillance camera.

In some embodiments, the pet food and power supply equipment includes a food bowl, a food dispenser and an ant-proof base. The food dispenser is connected to the food bowl to supply food to the food bowl. In addition, the ant-proof base is installed under the food bowl and the food dispenser to prevent ants from entering the food bowl and the food dispenser.

In some embodiments, the ant-proof base includes a plurality of ant-proof stands positioned underneath the ant-proof base.

In some embodiments, each ant-proof stand includes a plurality of ant-proof rings and an adjustable supporting column positioned at the center of the ant-proof rings.

In some embodiments, each power charger includes a power supply unit and a plurality of fastening claws arranged around the power supply unit.

In some embodiments, the power receiver of the pet water dispenser includes a power receiving unit and a plurality of fastening holes surrounding the power receiving unit to connect with the fastening claws.

In some embodiments, the power supply unit and power receiving unit utilize wireless charging, contact charging, connector charging, or spring contact charging.

In some embodiments, at least some of the power chargers in the pet food and power supply equipment are positioned at the same horizontal level.

Hence, the pet feeding device disclosed in the present invention can effectively adjust the quantity and relative positions of the pet food and power supply equipment, the pet water dispenser and the movable surveillance camera according to the environment and the number of pets. Additionally, the ant-proof base may effectively prevent contamination from insects such as ants.

### BRIEF DESCRIPTION OF THE DRAWINGS

The disclosure can be more fully understood by reading the following detailed description of the embodiment, with reference made to the accompanying drawings as follows:

FIG. 1 illustrates a schematic perspective view showing a pet feeding device in an assembled state according to one embodiment of the present invention;

FIG. 2 illustrates a schematic perspective view showing the pet feeding device in a disassembled state according to one embodiment of the present invention;

FIG. 3 illustrates a schematic perspective view showing the pet feeding device in a disassembled state according to one embodiment of the present invention from another view angle;

FIG. 4 illustrates a schematic perspective view showing an ant-proof base of the pet feeding device according to one embodiment of the present invention; and

FIG. 5 illustrates a schematic cross-sectional view of the ant-proof base of the pet feeding device according to one embodiment of the present invention.

### DETAILED DESCRIPTION OF THE PREFERRED EMBODIMENT

The following is a detailed description of the embodiments in conjunction with the accompanying drawings, but the provided embodiments are not intended to limit the scope of the disclosure, and the description of the structure and operation is not used to limit the execution sequence thereof. The structure of the recombination of components and the resulting devices with equal functions are all within the scope of this disclosure. In addition, the drawings are for illustration purposes only, and are not drawn according to the original scale. For ease of understanding, the same reference numbers are used in the drawings and the description to refer to the same or like parts.

In addition, the terms used in the entire description and the scope of the patent application, unless otherwise specified, usually have the usual meaning of each term used in this field, in the content disclosed here and in the special content. Some terms used to describe the disclosure are discussed below or elsewhere in this specification to provide additional guidance to those skilled in the art in the disclosure.

In the implementation mode and the scope of the present application, unless the article is specifically limited in the context, “a” and “the” can generally refer to a single or pluralities. In the steps, the numbering is only used to conveniently describe the steps, rather than to limit the sequence and implementation.

Secondly, the words “comprising”, “including”, “having”, “containing” and the like used in the present application are all open language, meaning including but not limited to.

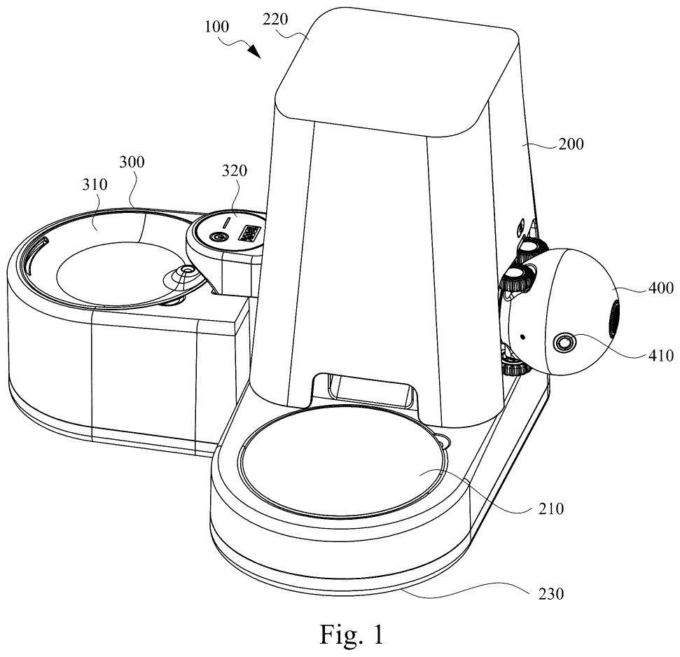

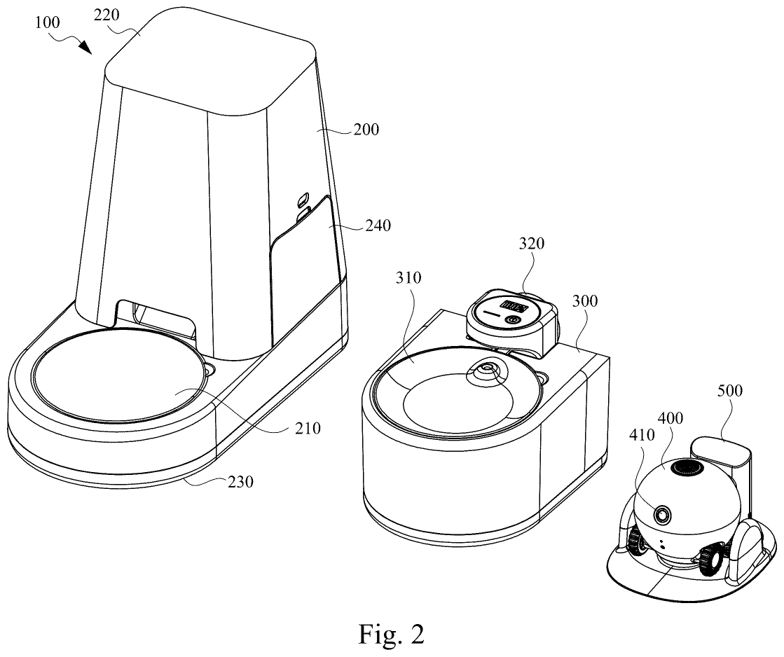

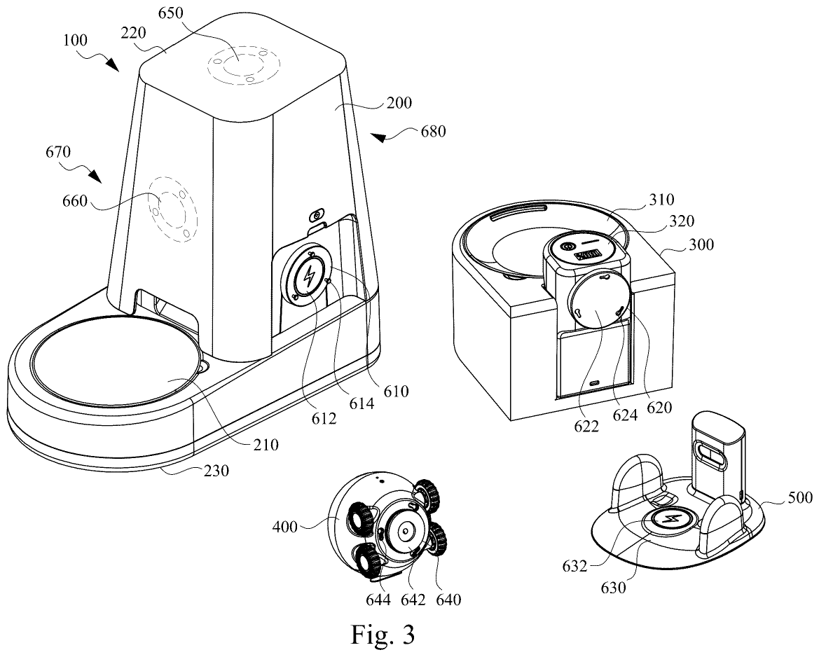

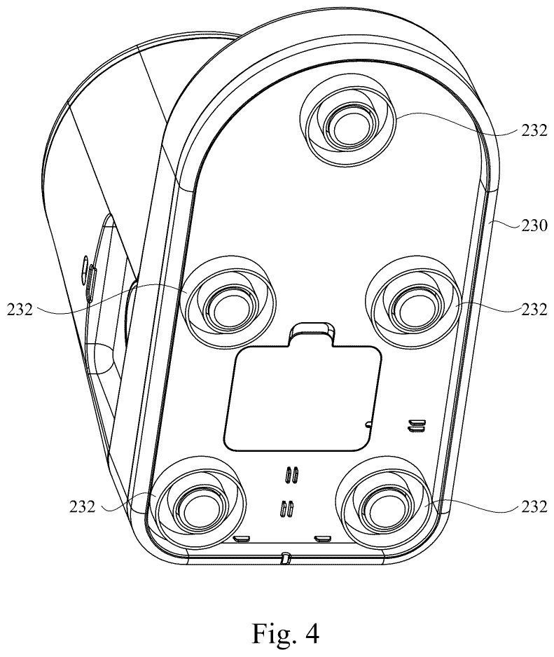

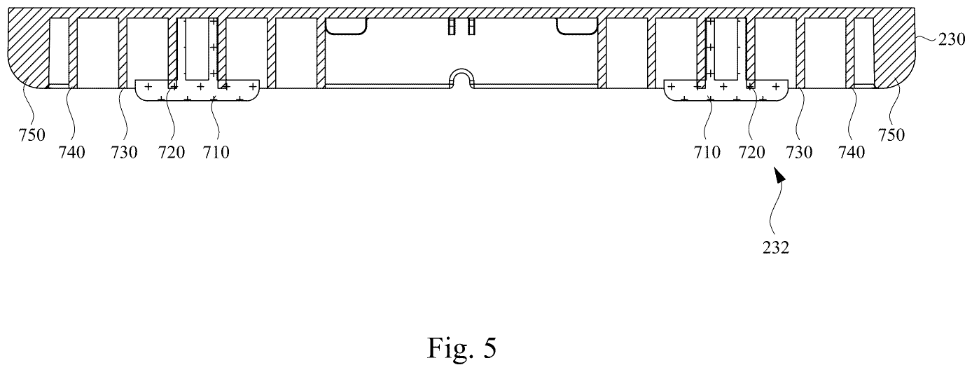

FIG. 1 illustrates a schematic perspective view showing a pet feeding device in an assembled state according to one embodiment of the present invention, FIG. 2 illustrates a schematic perspective view showing the pet feeding device in a disassembled state, and FIG. 3 illustrates a schematic perspective view of the pet feeding device in a disassembled state from another view angle. In addition, FIG. 4 illustrates a schematic perspective view showing an ant-proof base of the pet feeding device and FIG. 5 illustrates a schematic cross-sectional view of the ant-proof base of the pet feeding device.

FIGS. 1 to 3 illustrate an embodiment of a pet feeding device 100 including a pet food and power supply equipment 200, a pet water dispenser 300, and a movable surveillance camera 400. As shown in FIG. 3, a protective cover 240 of the pet food and power supply equipment 200 is removed to reveal the power charger 610 therein. The pet food and power supply equipment 200 includes a plurality of power chargers, such as a power charger 610, a power charger 650, a power charger 660, a power charger 670 and/or a power charger 680 but not limited thereto. The power chargers may be disposed at any position according to actual needs so as to conveniently install the pet water dispenser 300 and the movable surveillance camera 400 thereon without departing from the spirit and scope of the present application. Furthermore, a camera 410 is preferably equipped on the movable surveillance camera 400 for video recording.

In some embodiments, the power charger 610, the power charger 670, and the power charger 680 may be arranged at the same horizontal level to install the pet water dispenser 300 and/or the movable surveillance camera 400. In some embodiments, the power charger 610, the power charger 650, the power charger 660, the power charger 670, and the power charger 680 may be arranged at different positions to install the pet water dispenser 300 and/or the movable surveillance camera 400 according to actual needs.

Furthermore, the pet water dispenser 300 includes a power receiver 620 for electrically connecting to one of the power chargers so as to allow the power charger to supply the required power to the pet water dispenser 300. In addition, the relative positions of the pet water dispenser 300 and the pet food and power supply equipment 200 can be adjusted as actual needs.

In some embodiments, the movable surveillance camera 400 may also include a power receiver 640 able to electrically connect to any one of the power chargers of the pet food and power supply equipment 200. The power charger of the pet food and power supply equipment 200 may supply power to the movable surveillance camera 400. The relative positions of the movable surveillance camera 400 and the pet food and power supply equipment 200 may also be adjusted according to actual needs. In addition, the relative positions of the movable surveillance camera 400 and the pet water dispenser 300 fixed on the pet food and power supply equipment 200 may be exchanged according to actual needs.

Therefore, the pet feeding device 100 may be flexibly assembled according to the interior decoration design, the number of pets and any other considerations to select and assemble the required number of the pet food and power supply equipment 200, the pet water dispenser 300 and the movable surveillance camera 400.

In some embodiments, the power chargers and power receivers may be wireless charging devices, spring-type charging devices, contact-type charging devices, and/or wired charging devices, without departing from the spirit and scope of the present invention.

In some embodiments, the pet feeding device 100 further includes an independent charging base 500. The independent charging base 500 may be arranged at any positions outside the pet food and power supply equipment 200 to provide the required power to the movable surveillance camera 400. The independent charging base 500 may allow the movable surveillance camera 400 to be placed at any desired position for video recording so as to allow users to monitor the operation status of the pet feeding device 100 and observe the pet's eating and drinking status.

In some embodiments, as shown in FIG. 3, the power charger 610 may include a power supply unit 612 and a plurality of fastening claws 614, and the fastening claws 614 are arranged around the power supply unit 612.

In some embodiments, the independent charging base 500 includes a power charger 630, and the power charger 630 includes a power supply unit 632. In addition, the power charger 630 of the independent charging base 500 preferably has no fastening claws so as to facilitate the movement of the movable surveillance camera 400 to conveniently enter and exit the independent charging base 500.

In addition, the power receiver 620 of the pet water dispenser 300 includes a power receiving unit 622 and a plurality of fastening claw holes 624. The fastening claw holes 624 are arranged around the power receiving unit 622, and the fastening claw holes 624 may connect to the fastening claws 614.

Similarly, the power receiver 640 of the movable surveillance camera 400 may include a power receiving unit 642 and a plurality of fastening claw holes 644. The fastening claw holes 644 may be arranged around the power receiving unit 642 so as to conveniently connect to the fastening claws 614.

Therefore, the pet water dispenser 300 and the movable surveillance camera 400 can be selectively installed on any power charger of the pet food and power supply equipment 200 and secured by engaging the fastening claw holes 644 with the fastening claws 614.

The power supply unit 612, the power receiving unit 622, the power supply unit 632 and the power receiving unit 642 may utilize wireless charging, contact charging, connector charging and/or spring charging, all within the spirit and scope of the present invention.

In some embodiments, the pet food and power supply equipment 200 includes a food bowl 210 and a food dispenser 220. The food dispenser 220 connects to the food bowl 210 so as to provide a timed and quantified pet food according to the actual need.

In some embodiments, the pet food and power supply equipment 200 may also include an ant-proof base 230 under the food bowl 210 and the food dispenser 220 to prevent ants from entering the food bowl 210 and the food dispenser 220.

In some embodiments, the pet water dispenser 300 includes a water bowl 310 and a water supply unit 320. The water supply unit 320 connects to the water bowl 310 to provide a necessary drinking water so as to provide a timed and quantified drinking water according to actual needs. The ant-proof base 230 may also be equipped under the pet water dispenser 300.

In some embodiments, as shown in FIGS. 4 and 5, the ant-proof base 230 includes a plurality of ant-proof stand 232 equipped under the ant-proof base 230. The ant-proof stand 232 includes a plurality of ant-proof rings and an adjustable supporting column 710 positioned at the center of the ant-proof rings. The ant-proof rings include, for example, a first ant-proof ring 720, a second ant-proof ring 730, a third ant-proof ring 740 and/or a fourth ant-proof ring 750. The adjustable supporting column 710 is equipped in the first ant-proof ring 720 to adjust the level and height of the pet food and power supply equipment 200 and the pet water dispenser 300.

Accordingly, the pet feeding device disclosed in the present invention may flexibly assemble and adjust the quantities and relative positions of the pet food and power supply equipment, the pet water dispenser and the movable surveillance camera according to the environment and number of the pets. In addition, the pet feeding device disclosed in the present invention can also utilize an ant-proof base to effectively prevent food from being contaminated by insects such as ants. Furthermore, the pet food and power supply equipment, the pet water dispenser and the movable surveillance camera may also be powered and used independently, without departing from the spirit and protection scope of the present invention.

Although the present disclosure has been disclosed above in terms of implementation, it is not intended to limit the present disclosure. Any person with ordinary knowledge in the field may make various variations and modifications without departing from the spirit and scope of the disclosure. Therefore, the spirit and scope of the appended claims should not be limited to the description of the embodiments contained herein.

1. A pet feeding device, comprising:
a pet food and power supply equipment, wherein the pet food and power supply equipment comprises a plurality of power chargers; and
a pet water dispenser, wherein the pet water dispenser comprises a power receiver for electrically connecting one of the power chargers to provide a required power to the pet water dispenser, and relative positions of the pet water dispenser and the pet food and power supply equipment are adjustable, wherein each of the power chargers comprises a power supply unit and a plurality of fastening claws arranged around the power supply unit.

2. The pet feeding device of claim 1, further comprising:
a movable surveillance camera, wherein the movable surveillance camera comprises a power receiver for electrically connecting another one of the power chargers to provide a required power to the movable surveillance camera, and relative positions of the movable surveillance camera and the pet water dispenser are exchangeable.

3. The pet feeding device of claim 2, further comprising:
an independent charging base located outside the pet food and power supply equipment to provide a required power to the movable surveillance camera.

4. The pet feeding device of claim 2, wherein the pet food and power supply equipment comprises:
a food bowl;
a food dispenser connected to the food bowl to supply food to the food bowl; and
an ant-proof base equipped under the food bowl and the food dispenser to prevent ants from entering the food bowl and the food dispenser.

5. The pet feeding device of claim 4, wherein the ant-proof base comprises a plurality of ant-proof stands disposed under the ant-proof base.

6. The pet feeding device according to claim 5, wherein each of the ant-proof stands comprises:
a plurality ant-proof rings; and
an adjustable supporting column positioned at a center of the ant-proof rings.

7. (canceled)

8. The pet feeding device according to claim 6, wherein the power receiver of the pet water dispenser comprises:
a power receiving unit; and
a plurality of fastening holes surrounding the power receiving unit to connect with the fastening claws.

9. The pet feeding device according to claim 8, wherein the power supply unit and the power receiving unit utilize wireless charging, contact charging, connector charging, or spring contact charging.

10. The pet feeding device according to claim 1, wherein at least two power chargers of the power chargers of the pet food and power supply equipment are positioned at a same horizontal level.
